(19) United States
(12) Patent Application Publication
(10) Pub. No.: US 2003/0199274 A1
(43) Pub. Date: Oct. 23, 2003

(54) Method for providing calling information in a mobile communication system

(75) Inventor: Seok-Hun Lim, Suwon-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., Kyungki-do (KR)

(21) Appl. No.: 10/410,451

(22) Filed: Apr. 9, 2003

(30) Foreign Application Priority Data
Apr. 19, 2002 (KR) 2002-21650

(51) Int. Cl. H04Q 7/20

(52) U.S. Cl. 455/445; 455/466

(57) ABSTRACT

A method for providing calling information in a mobile communication system. When a called mobile communication terminal is in a state in which it cannot be connected to or a calling mobile communication terminal cancels a call connection request while the call connection request is in progress, the present invention converts a calling number of a mobile communication terminal attempting to make a call connection into a short message, and transmits the short message having the calling number to the called mobile communication terminal.

### PRIORITY

This application claims priority to an application entitled “METHOD FOR PROVIDING CALL ORIGINATOR INFORMATION IN MOBILE COMMUNICATION SYSTEM”, filed in the Korean Industrial Property Office on Apr. 19, 2002 and assigned Serial No. 2002-21650, the contents of which are hereby incorporated by reference.

### BACKGROUND OF THE INVENTION

1. Field of the Invention

The present invention relates to a mobile communication system, and more particularly to a method for providing calling information in a mobile communication system.

2. Description of the Related Art

Generally, when a mobile switching center (MSC) in a mobile communication system receives a call connection request between a calling mobile communication terminal and a called mobile communication terminal powered off or located in an area where signal reception is impossible, it connects the calling mobile communication terminal to a voice message server (VMS). Then, the mobile switching center sends a message indicating a connection with the voice message server to the calling mobile communication terminal. Therefore, a user of the calling mobile communication terminal selectively records his or her voice message in the voice message server. When the user of the calling mobile communication terminal does not record his or her voice message in the voice message server, namely, when the user does not want to leave a voice message, the mobile switching center transmits no information of the call originator to the called mobile communication terminal. Herein, the calling information is the information concerning the calling mobile communication terminal, and corresponds to a calling number such as a phone number. As a result, a user of the called mobile communication terminal cannot recognize which mobile communication terminal transmitted the call connection request in the impossible call connection state. Also, when the calling mobile communication terminal cancels a call connection request while the call connection request is in progress after a call connection attempt, the user of the called mobile communication terminal cannot recognize which mobile communication terminal transmitted the call connection request.

### SUMMARY OF THE INVENTION

Therefore, the present invention has been designed in view of the above problems, and it is an object of the present invention to provide a method for providing calling information, which provides calling information of a mobile communication terminal attempting to make a call connection when a called mobile communication terminal cannot be connected to.

It is another object of the present invention to provide a method for providing calling information, which provides calling information of a mobile communication terminal attempting to make a call connection when a calling mobile communication terminal cancels a call connection request while the call connection request is in progress.

In accordance with one aspect of the present invention, the above and other objects can be accomplished by a method for providing calling information in a mobile communication system, comprising the steps of: a) if an arbitrary communication terminal transmits a call connection request, performing a call connection operation; b) upon receiving the call connection operation result, if the call connection operation fails, connecting the arbitrary communication terminal to a voice message server, and determining whether a voice message transmission request is received from the arbitrary communication terminal; and c) if there is no voice message transmission request from the arbitrary communication terminal, extracting calling information of the arbitrary communication terminal, converting the calling information into a short message, and transmitting the short message having the calling information to a called mobile communication terminal.

In accordance with another aspect of the present invention, there is provided a method for providing calling information in a mobile communication system, comprising the steps of a) performing a call connection operation between an arbitrary communication terminal and a called mobile communication terminal, after receiving a call connection request message from the arbitrary communication terminal; b) upon receiving the call connection operation result, if the call connection operation fails, analyzing the call connection request message; and c) upon receiving the analyzed result, if the call connection request message includes a short message conversion code, extracting calling information of the arbitrary communication terminal, converting the calling information into a short message, and transmitting the short message having the calling information to the called mobile communication terminal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a mobile communication system in accordance with the present invention;

FIG. 2 is a flow chart illustrating a processing procedure of a mobile switching center in accordance with a preferred embodiment of the present invention;

FIG. 3 is a flow chart illustrating a processing procedure of a mobile switching center in accordance with another preferred embodiment of the present invention;

FIG. 4 is a block diagram illustrating a mobile communication terminal in accordance with the present invention; and

FIG. 5 is a flow chart illustrating a processing procedure of a mobile switching center in accordance with a still another preferred embodiment of the present invention.

### DETAILED DESCRIPTION OF THE PREFERRED EMBODIMENTS

Preferred embodiments of the present invention will be described in detail herein below with reference to the annexed drawings. In the drawings, the same or similar elements are denoted by same reference numerals even though they are depicted in different drawings. In the following description, a detailed description of known functions and configurations incorporated herein will be omitted when it may make the subject matter of the present invention rather unclear.

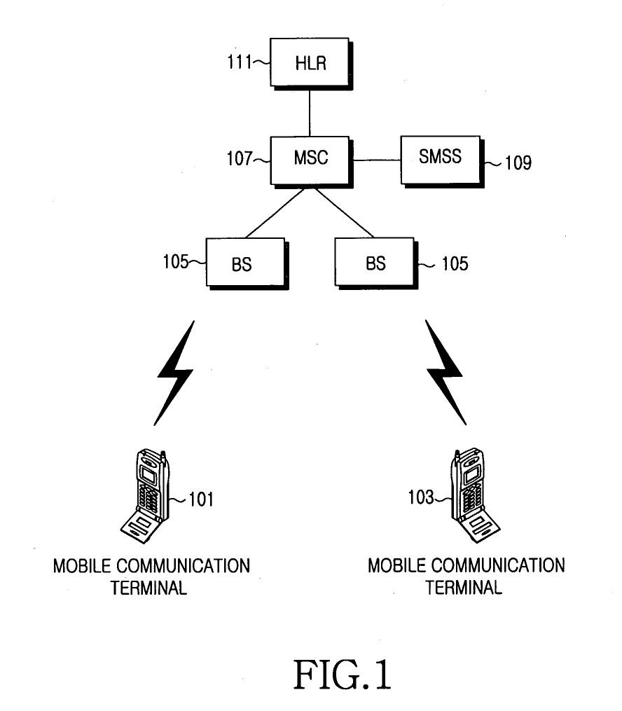

FIG. 1 is a block diagram illustrating a mobile communication system in accordance with the present invention. As illustrated in FIG. 1, a mobile communication system comprises mobile communication terminals 101 and 103, two BSs (Base Transceiver Station/Base Station Controllers) 105, an MSC (Mobile Switching Center) 107, an SMSS (Short Message Service Server) 109, and an HLR (Home Location Register) 111. The BSs 105 communicate with the mobile communication terminals 101 and 103 via a radio communication area, control a wireless link and a wired link, and perform a handoff function for maintaining a call connection state even while a subscriber is in motion.

The MSC 107 is network-interworked with another MSC to process call origination/termination requests from the mobile communication terminals 101 and 103, and inquires of the HLR 111 about subscribers. The MSC 107 is also network-interworked with a wired network. In the case where the MSC 107 receives a short message from the mobile communication terminals 101 and 103, it sends the short message to an SMSS 109. Also, if the MSC 107 receives a short message from the SMSS 109, then it transmits the short message to the BSs 105 in such a way that the short message is transmitted to the mobile communication terminals 101 and 103 via a paging channel. Then, the MSC 107 extracts a calling number of a calling mobile communication terminal, converts the calling number into a short message, and then transmits the short message having the calling number to the SMSS 109.

The HLR is a medium-sized computer mainly used for managing the mobile communication terminal subscribers. The HLR stores the information of subscribers and location/state information of mobile communication terminals, and performs a routing of a termination call.

The SMSS 109 is an independent node, and is connected to the HLR 111 and the MSC 107 to recognize a location of a called mobile communication terminal so that a short message is transmitted to the recognized, call terminator. When transmitting/receiving a short message that is transmitted to a called mobile communication terminal that cannot be connected to at an arbitrary time, the SMSS 109 stores the short message for a predetermined period of time and then forwards it. The SMSS 109 receives a short message originated from the mobile communication terminals 101 and 103 via the BSs 105 and the MSC 107, or stores a short message received from the MSC 107 in a message queue. Also, the SMSS 109 analyzes the called mobile communication terminal's number (hereinafter referred to as a called number) received along with the short message, tracks a location of a corresponding mobile communication terminal by interworking with the HLR 111 upon receiving the analyzed result, and then transmits the short message to the corresponding mobile communication terminal.

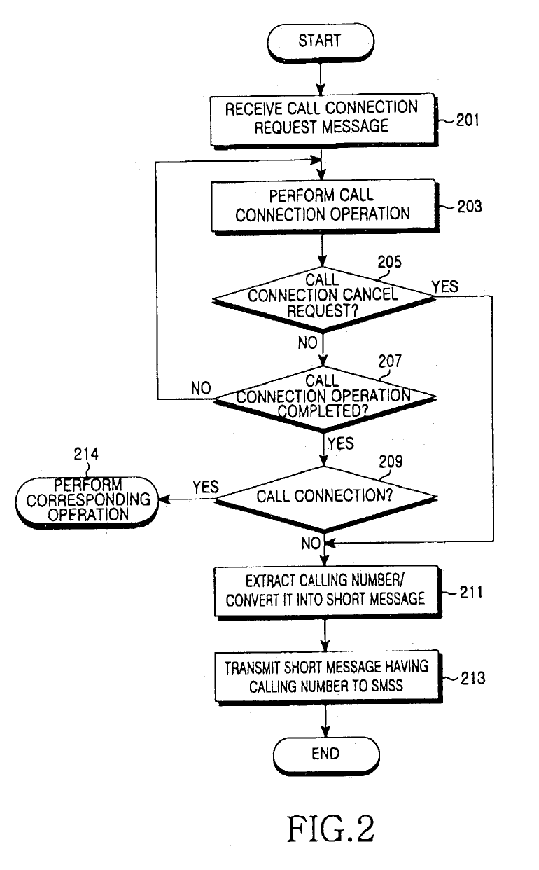

The required operations of the MSC 107 in the aforementioned mobile communication system will hereinafter be described with reference to FIGS. 2, 3, and 5.

In accordance with a preferred embodiment of the present invention, if an arbitrary communication terminal transmits a call connection request message, then an MSC 107 performs a call connection operation. Namely, the MSC 107 extracts a called number from the call connection request message received from the arbitrary communication terminal, and searches the state information of a called mobile communication terminal by interworking with a HLR 111. When the called mobile communication terminal is in a call connection available state, upon receiving the searched result, the MSC 107 tracks a location of the called mobile communication terminal, and attempts to make a call connection with the called mobile communication terminal via a corresponding BS 105. In this case, if the MSC 107 fails to make a call connection with the called mobile communication terminal, or fails in call termination because the called mobile communication terminal is powered off or located in an area in which reception is impossible, it extracts a phone number (i.e., a calling number) of the arbitrary communication terminal and converts it into a short message. When the MSC 107 receives a call connection cancel request from the calling mobile communication terminal while a call connection operation is in progress, it extracts the calling number and converts it into a short message. Thereafter, the MSC 107 transmits the short message having the calling number to an SMSS 109. The SMSS 109 processes the received short message having the calling number according to a common short message process.

A processing procedure of the aforementioned MSC 107 will hereinafter be described with reference to FIG. 2. FIG. 2 is a flow chart illustrating a processing procedure of the MSC 107 in accordance with a preferred embodiment of the present invention. Referring to FIG. 2, if an MSC 107 receives a call connection request message from an arbitrary communication terminal in step 201, then it goes to step 203. The MSC 107 performs a call connection operation in step 203, and then goes to step 205. The MSC 107 determines in step 205 whether a call connection cancel request message is received from the arbitrary communication terminal. If the MSC 107 detects the call connection cancel request message in step 205, then it goes to step 211. If there is no call connection cancel request message in step 205, the MSC 107 goes to step 207. The call connection cancel request message corresponds to an on-hook action if the arbitrary communication terminal is a wired terminal, or corresponds to an end key input action if the arbitrary communication terminal is a mobile communication terminal. The MSC 107 determines in step 207 whether a call connection operation is completed. If the call connection operation is completed in step 207, then the MSC 107 goes to step 209. If the call connection operation is not completed in step 207, then the MSC 107 returns to step 203. The MSC 107 determines in step 209 whether a call connection with the called mobile communication terminal is made. If the call connection between the MSC 107 and the called mobile communication terminal is made in step 209, then the MSC 107 goes to step 214. If the call connection between them is not made in step 209, then the MSC 107 goes to step 211. The MSC 107 performs a corresponding operation accompanied by the call connection in step 214.

In the meantime, if the MSC 107 fails to make the call connection in step 209, it extracts a calling number and converts it into a short message in step 211, and then goes to step 213. The MSC 107 transmits the calling number short message to a SMSS 109 in step 213, and then terminates a program as illustrated in FIG. 2.

The SMSS 109 processes the received calling number short message according to a common short message process.

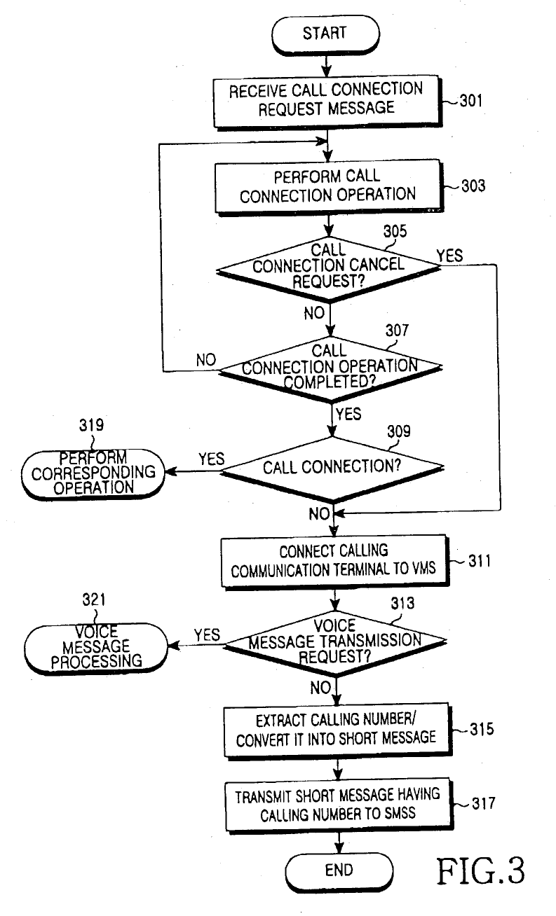

The preferred embodiment shown in FIG. 2 illustrates a specific case where the MSC 107 compulsorily transmits the calling number short message when a call connection fails. Another embodiment of the present invention illustrates another case in which the MSC 107 transmits a calling number short message under the condition that a user of a calling mobile communication terminal does not input his or her voice message transmission request in a voice message server, when connecting the calling mobile communication terminal to the voice message server after a call connection failure of the MSC 107. The voice message server records a user's voice by his or her desired selection, stores it for a predetermined period of time, and then forwards it. A called mobile communication terminal will hereinafter be described with reference to FIG. 3.

FIG. 3 is a flow chart illustrating a processing procedure of a MSC in accordance with another preferred embodiment of the present invention. Referring to FIG. 3, if an MSC 107 receives a call connection request message from an arbitrary communication terminal in step 301, then it goes to step 303, where the MSC 107 performs a call connection operation, and then goes to step 305. The MSC 107 determines in step 305 whether a call connection cancel request message is received from the arbitrary communication terminal. If the MSC 107 detects the call connection cancel request message in step 305, then it goes to step 311. If there is no call connection cancel request message in step 305, then the MSC 107 goes to step 307. The MSC 107 determines in step 307 whether a call connection operation is completed. If the call connection operation is completed in step 307, then the MSC 107 goes to step 309. If the call connection operation is not completed in step 307, then the MSC 107 returns to step 303. The MSC 107 determines in step 309 whether a call connection with the called mobile communication terminal is made. If the call connection between the MSC 107 and the called mobile communication terminal is made in step 309, then the MSC 107 goes to step 319. If the call connection between them is not made in step 309, then the MSC 107 goes to step 311. The MSC 107 performs a corresponding operation accompanied by the call connection in step 319.

On the other hand, the MSC 107 connects the call origination communication terminal to the voice message server in step 311, and then goes to step 313. The MSC 107 determines in step 313 whether a voice message transmission request is received from the call origination communication terminal. In other words, the MSC 107 determines in step 313 whether a user of the call origination communication terminal records his or her voice message or inputs a message transmission authorization command. If the voice message transmission request is received from the call origination communication terminal in step 313, then the MSC 107 goes to step 321 and processes a recorded voice message. If there is no voice message transmission request from the call origination communication terminal in step 313, then the MSC 107 goes to step 315. Since there is no voice message transmission request from the call origination communication terminal in step 313, the MSC 107 extracts a calling number and converts it into a short message in step 315, and then goes to step 317. The MSC 107 transmits the calling number short message to an SMSS 109 in step 317, and then terminates a program as illustrated in FIG. 3.

The SMSS 109 processes the received calling number short message according to a common short message process.

In still another preferred embodiment of the present invention, a predetermined menu for providing a mobile communication terminal with calling information is added to a call origination communication terminal such as a mobile communication terminal. If there is no voice message transmission request when the call origination communication terminal is connected to a voice message server after a call connection failure, an MSC 107 provides the calling information by a menu selection signal.

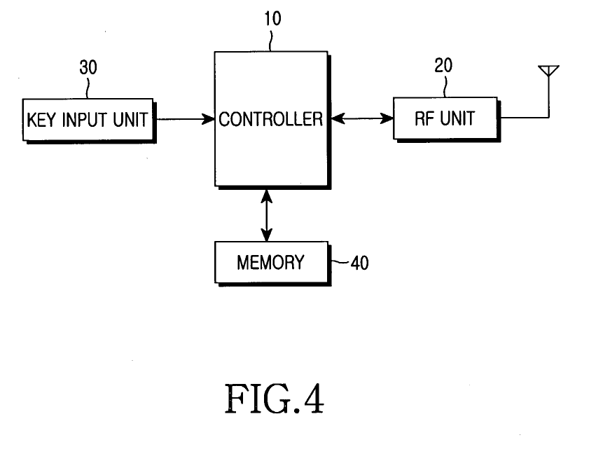

A configuration of the mobile communication terminal according to the above still another preferred embodiment is illustrated in FIG. 4. FIG. 4 is a block diagram illustrating a mobile communication terminal in accordance with the present invention.

As illustrated in FIG. 4, the mobile communication terminal in accordance with the still another preferred embodiment comprises a controller 10, an RF (Radio Frequency) unit 20, a key input unit 30, and a memory 40. The controller 10 performs the entire control operations of the mobile communication terminal. Upon receiving a control signal from the controller 10, the RF unit 60 controls transmission/reception operations of voice data and control data. The key input unit 30 includes a plurality of numerical keys and function keys, and transmits a key input data corresponding to a user's selection key to the controller 10. The memory 40 stores program data needed to control the mobile communication terminal, and stores arbitrary data produced by either a user or a control step. Furthermore, the memory 40 stores other program data concerning the menu for providing the calling information.

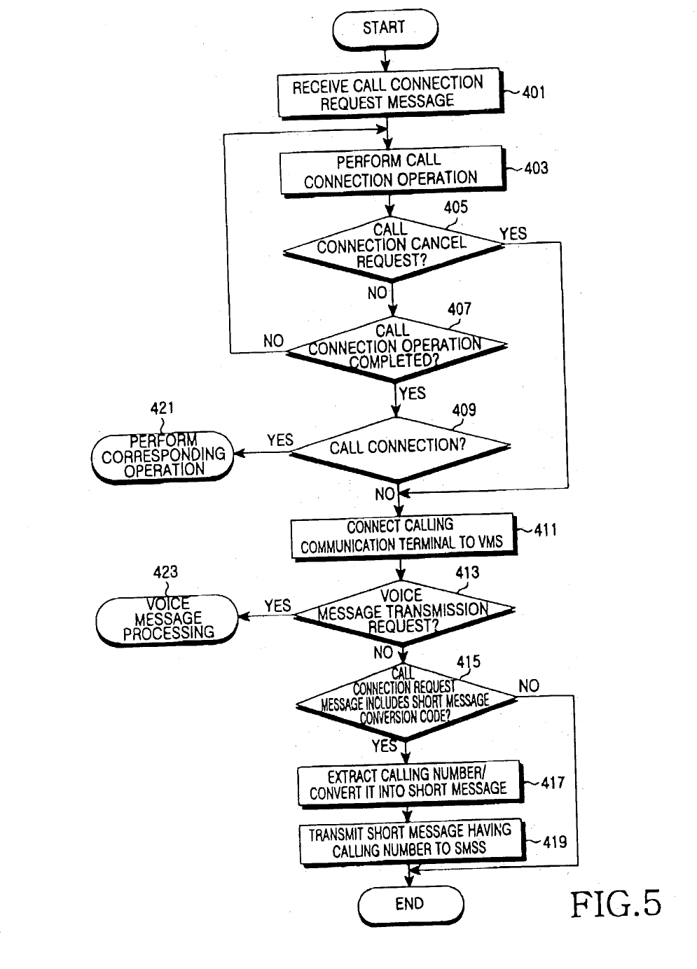

The menu for providing the calling information is adapted to set a calling information providing mode. By the calling information providing mode, a short message conversion code is added to a call connection request message transmitted from a mobile communication terminal to an MSC 107 at a call origination. When the MSC 107 receives a call connection request message having the short message conversion code, it converts a calling number to a short message. For this purpose, the required operations of the MSC 107 will hereinafter be described with reference to FIG. 5.

FIG. 5 is a flow chart illustrating a processing procedure of an MSC in accordance with still another preferred embodiment of the present invention. Referring to FIG. 5, if the MSC 107 receives a call connection request message from an arbitrary communication terminal in step 401, then it goes to step 403 and performs a call connection operation, and then goes to step 405. The MSC 107 determines in step 405 whether a call connection cancel request message is received from the arbitrary communication terminal. If the MSC 107 detects the call connection cancel request message in step 405, then it goes to step 411. If there is no call connection cancel request message in step 405, then the MSC 107 goes to step 407 and determines whether a call connection operation is completed. If the call connection operation is completed in step 407, then the MSC 107 goes to step 409. If the call connection operation is not completed in step 407, then the MSC 107 returns to step 403. The MSC 107 determines in step 409 whether a call connection with the called mobile communication terminal is made. If the call connection between the MSC 107 and the called mobile communication terminal is made in step 409, then the MSC 107 goes to step 421 and performs a corresponding operation accompanied by the call connection. If the call connection is not made in step 409, then the MSC 107 goes to step 411.

The MSC 107 connects the call origination communication terminal to the voice message server in step 411, and then goes to step 413. The MSC 107 determines in step 413 whether a voice message transmission request is received from the call origination communication terminal. If the voice message transmission request is received from the call origination communication terminal in step 413, then the MSC 107 goes to step 423. If there is no voice message transmission request from the call origination communication terminal in step 413, then the MSC 107 goes to step 415 and determines whether the call connection request message includes the short message conversion code. If the call connection request message includes the short message conversion code in step 415, then the MSC-107 goes to step 417. If there is no short message conversion code in the call connection request message in step 415, then the MSC 107 terminates the program.

If the call connection request message includes the short message conversion code in step 415, the MSC 107 extracts a calling number and converts it into a short message in step 417, and then goes to step 419. The MSC 107 transmits the calling number short message to an SMSS 109 in step 419, and then terminates the program as illustrated in FIG. 5.

The SMSS 109 processes the received calling number short message according to a common short message process.

While the present invention has been described above as providing an SMS (Short Message Service), the present invention is also applicable for providing an MMS (Multimedia Message Service), such as transmitting JPEG, MPEG, or MP3 files.

As apparent from the above description, when a called mobile communication terminal is in a state in which it cannot be connected to or the call origination communication terminal cancels a call connection request while the call connection request is in progress, the present invention provides calling information of a mobile communication terminal attempting to make a call connection in such a way that it enhances a user's convenience.

Although the preferred embodiments of the present invention have been disclosed for illustrative purposes, those skilled in the art will appreciate that various modifications, additions, and substitutions are possible, without departing from the scope and spirit of the invention as disclosed in the accompanying claims.

What is claimed is:

1. A method for providing calling information in a mobile communication system, comprising the steps of:
performing a call connection operation between an arbitrary communication terminal and a called mobile communication terminal, after receiving a call connection request from the arbitrary communication terminal; and
if there is a call origination cancel request from the arbitrary communication terminal during the call connection operation, extracting calling information of the arbitrary communication terminal, converting the calling information into a message, and transmitting the message having the calling information to the called mobile communication terminal.

2. The method as set forth in claim 1, wherein the message having the calling information is one of an SMS (Short Message Service) and an MMS (Multimedia Message Service) message.

3. The method as set forth in claim 1, further comprising the step of:
upon receiving a call connection operation result, if the call connection operation between the arbitrary communication terminal and the called mobile communication terminal fails, extracting calling information of the arbitrary communication terminal, converting the calling information into a message, and transmitting the message having the calling information to the called mobile communication terminal.

4. The method as set forth in claim 3, wherein the message having the calling information is one of an SMS (Short Message Service) and an MMS (Multimedia Message Service) message.

5. A method for providing calling information in a mobile communication system, comprising the steps of:
if an arbitrary communication terminal transmits a call connection request, performing a call connection operation;
upon receiving a call connection operation result, if the call connection operation fails, connecting the arbitrary communication terminal to a voice message server, and determining whether a voice message transmission request is received from the arbitrary communication terminal; and
if there is no voice message transmission request from the arbitrary communication terminal, extracting calling information of the arbitrary communication terminal, converting the calling information into a message, and transmitting the message having the calling information to a called mobile communication terminal.

6. The method as set forth in claim 5, wherein the message having the calling information is one of an SMS (Short Message Service) and an MMS (Multimedia Message Service) message.

7. The method as set forth in claim 5, further comprising the step of:
if there is a call origination cancel request from the arbitrary communication terminal during the call connection operation, extracting calling information of the arbitrary communication terminal, converting the calling information into a message, and transmitting the message having the calling information to the called mobile communication terminal.

8. The method as set forth in claim 7, wherein the message having the calling information is one of an SMS (Short Message Service) and an MMS (Multimedia Message Service) message.

9. A method for providing calling information in a mobile communication system, comprising the steps of:
performing a call connection operation between an arbitrary communication terminal and a called mobile communication terminal, after receiving a call connection request message from the arbitrary communication terminal;
upon receiving a call connection operation result, if the call connection operation fails, analyzing the call connection request message; and
upon receiving an analyzed result, if the call connection request message includes a message conversion code, extracting calling information of the arbitrary communication terminal, converting the calling information into a message, and transmitting the message having the calling information to the called mobile communication terminal.

10. The method as set forth in claim 9, wherein the message having the calling information is one of an SMS (Short Message Service) and an MMS (Multimedia Message Service) message.

11. The method as set forth in claim 9, further comprising the steps of:
if there is a call origination cancel request from the arbitrary communication terminal during the call connection operation, analyzing the call connection request message; and
upon receiving an analyzed result, if the call connection request message includes a message conversion code, extracting a phone number of the arbitrary communication terminal, converting the phone number into a message, and transmitting the message having the phone number to the called mobile communication terminal.

12. The method as set forth in claim 11, wherein the message having the calling information is one of an SMS (Short Message Service) and an MMS (Multimedia Message Service) message.
